(19) United States
(12) Patent Application Publication
(10) Pub. No.: US 2015/0052574 A1
(43) Pub. Date: Feb. 19, 2015

(54) SOFTWARE DEFINED ATSC TV DEMODULATOR WITH WI-FI TUNERS

(71) Applicant: M&A Holdings, San Jose, CA (US)

(72) Inventor: Lin Yang, Milpitas, CA (US)

(73) Assignee: M&A HOLDINGS, San Jose, CA (US)

(21) Appl. No.: 13/969,319

(22) Filed: Aug. 16, 2013

(51) Int. Cl. H04N 21/426; H04N 21/438

(52) U.S. Cl. CPC H04N 21/4263; H04N 21/4382
USPC 725/133

(57) ABSTRACT

The present invention provides an implementation method for a Software Defined ATSC TV Demodulator with Wi-Fi Tuners. The method includes the wireless interface between the ATSC TV tuner and the computing platform, the wireless interface (Wi-Fi) transport stream protocol, and the vector-based digital signal processing algorithm for each individual functional block.

### TECHNICAL FIELD

The present invention relates generally to an application in a digital television system, more specifically the present invention relates to a multiple antenna ATSC terrestrial DTV receiver implemented on a computing platform (PC, laptop, tablet, smart phone, wearable computing device, Set-Top-Box, Over-The-Top box, etc.) for indoor and mobile users.

### BACKGROUND

The television antenna has existed for decades, and has traditionally been mounted on rooftops and connected to the TV with a long wire. TVs have become thinner, sleeker, and available in more formats (portable TV, tablet, cell phone, etc.). The wired connection between the antenna and the above-mentioned TV-viewing device needs to be replaced with a wireless connection to cater to these new formats.

Recent advances in Wi-Fi technology have enabled very high speed transfer rates (1 Gbps). Due to this high speed, Wi-Fi now has the means to wirelessly connect single or multiple antennas to the TV viewing device.

Single carrier terrestrial digital television systems (ATSC standard) are deployed in the United States, Canada, and other countries. ATSC HDTV signals are subject to multipath with Doppler interference in indoor, outdoor, and mobile environments. Currently, only single-antenna ATSC HDTV receivers exist. For existing single-antenna applications, an equalizer can be used to remove the static multipath interference. To improve reception, multiple antennas should be used. However, no existing ATSC HDTV receiver can efficiently combine multiple antenna signals to make it perform better than a single antenna. This is because the multiple Doppler multipath generated by the multiple antennas are cross-interfering.

Traditionally, the TV receiver is implemented using application-specific integrated circuit (ASIC) chips. For the past decade, computing technology has progressed rapidly—resulting in smaller, more powerful CPUs and GPUs. Nowadays, most consumer electronic devices (PC, laptop, tablet, smart TV, smart phone, wearable computing device, etc.) have embedded powerful CPUs/GPUs. This makes it possible to replace a dedicated TV receiver ASIC chip with a software defined ATSC TV demodulator.

The following patents are herein incorporated by reference: U.S. patent application Ser. No. 12/512,901 entitled A NOVEL EQUALIZER FOR SINGLE CARRIER TERRESTRIAL DTV RECEIVER, by Yang; U.S. patent application Ser. No. 12/554,925 entitled A MULTIPLE TUNER ATSC TERRESTRIAL RECEIVER FOR INDOOR & MOBILE USERS, by Yang; U.S. patent application Ser. No. 12/572,236 entitled A MULTIPLE TUNER TERRESTRIAL DTV RECEIVER FOR INDOOR & MOBILE USERS, by Yang; U.S. patent application Ser. No. 13/871,869 entitled WI-Fl ATSC TV ANTENNA, by Yang; U.S. patent application Ser. No. 13/872,917 entitled MULTIPLE ANTENNA ATSC HDTV RECEIVER DEVICE, by Yang; U.S. patent application Ser. No. 13/889,158 entitled A METHOD OF CHANNEL CHARACTERIZATION FOR MOBILE ATSC HDTV RECEIVER, by Yang; U.S. patent application Ser. No. 13/890,097 entitled CHANNEL STATE INFORMATION ASSISTED DECISION FEEDBACK EQUALIZER FOR MOBILE ATSC HDTV RECEIVER, by Yang; U.S. patent application Ser. No. 13/892,504 entitled ATSC TERRESTRIAL TV ANTENNA NETWORK, by Yang; U.S. patent application Ser. No. 13/896,191 entitled A METHOD OF ATSC MH STREAM ASSISTED CHANNEL CHARACTERIZATION FOR MOBILE ATSC TV RECEIVER, by Yang; U.S. patent application Ser. No. 13/902,947 entitled WI-FI ATSC TV ANTENNA WITH WAVEFORM COMPRESSION, by Yang; U.S. patent application Ser. No. 13/918,803 entitled MULTIPLE WI-FI ATSC TV ANTENNA RECEIVER, by Yang.

In addition to the above-referenced applications, the present invention provides an implementation method for a Software Defined ATSC TV Demodulator with Wi-Fi Tuners. The method includes the wireless interface between the ATSC TV tuner and the computing platform, the wireless interface (Wi-Fi) transport stream format, and the vector-based digital signal processing algorithm for each individual functional block.

### SUMMARY

The present invention provides an implementation method for a Software Defined ATSC TV Demodulator with Wi-Fi Tuners. The method includes the wireless interface between the ATSC TV tuner and the computing platform, the wireless interface (Wi-Fi) transport stream format, and the vector-based digital signal processing algorithm for each individual functional block.

### BRIEF DESCRIPTION OF DRAWINGS

Having thus described the invention in general terms, reference will now be made to the accompanying drawings, which are not necessarily drawn to scale, and wherein:

FIG. 1 shows schematically a block diagram of the Software Defined ATSC TV Demodulator with Wi-Fi Tuners according to one embodiment of the present invention.

FIG. 2 shows schematically a block diagram of the Single Antenna with Multiple Tuners according to one embodiment of the present invention.

FIG. 3 shows schematically a block diagram of the Multiple Antenna-Tuner Pairs according to one embodiment of the present invention.

FIG. 4 shows schematically a block diagram of the Multiple Antennas with Multiple Tuners according to one embodiment of the present invention.

FIG. 5 shows schematically a block diagram of the Wi-Fi TV Antenna according to one embodiment of the present invention.

FIG. 6 shows schematically a block diagram of the TV Signal to Wi-Fi Signal Adapter according to one embodiment of the present invention.

FIG. 7 shows schematically a block diagram of the Computing platform (PC, tablet, smart TV, OTT box, etc.) according to one embodiment of the present invention.

FIG. 8 shows schematically a block diagram of the Software Defined ATSC TV Demodulator Programming Diagram according to one embodiment of the present invention.

FIG. 9 shows schematically a block diagram of the IF to Baseband Down-conversion and Signal Synchronization Functional Block according to one embodiment of the present invention.

FIG. 10 shows schematically a block diagram of the Channel State Information (CSI) and Signal-To-Noise-Ratio (SNR) Estimation Functional Block according to one embodiment of the present invention.

FIG. 11 shows schematically a block diagram of the Time Domain Maximum Ratio Combining (MRC) Equalizer Functional Block according to one embodiment of the present invention.

### DETAILED DESCRIPTION

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

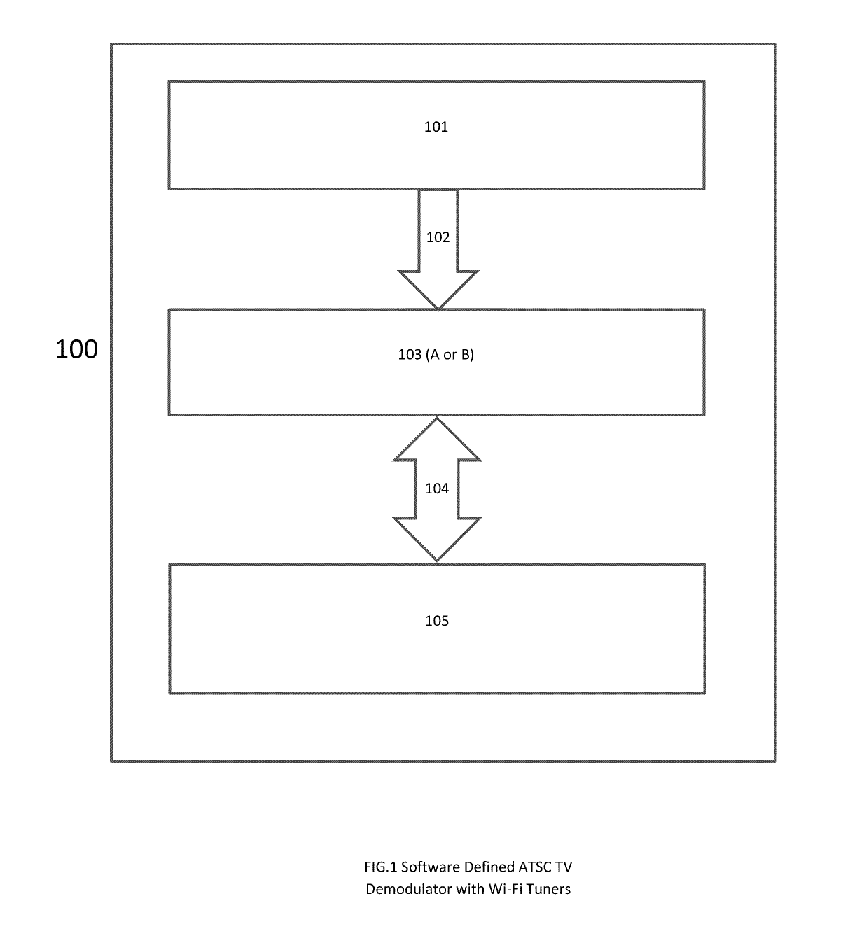

FIG. 1: 100—Software Defined ATSC TV Demodulator with Wi-Fi Tuners
101—Terrestrial TV Antenna (one or more)
102—Antenna cables to tuners (one or more)
103—Wi-Fi TV Antenna Module
   103A—Single Antenna with Multiple Tuners
   103B—Multiple Antenna-Tuner Pairs
   103C—Multiple Antennas with Multiple Tuners
104—Wi-Fi RF Signal
105—Computing platform (PC, tablet, smart TV, Set-Top-Box, wearable computer, OTT box, etc.)

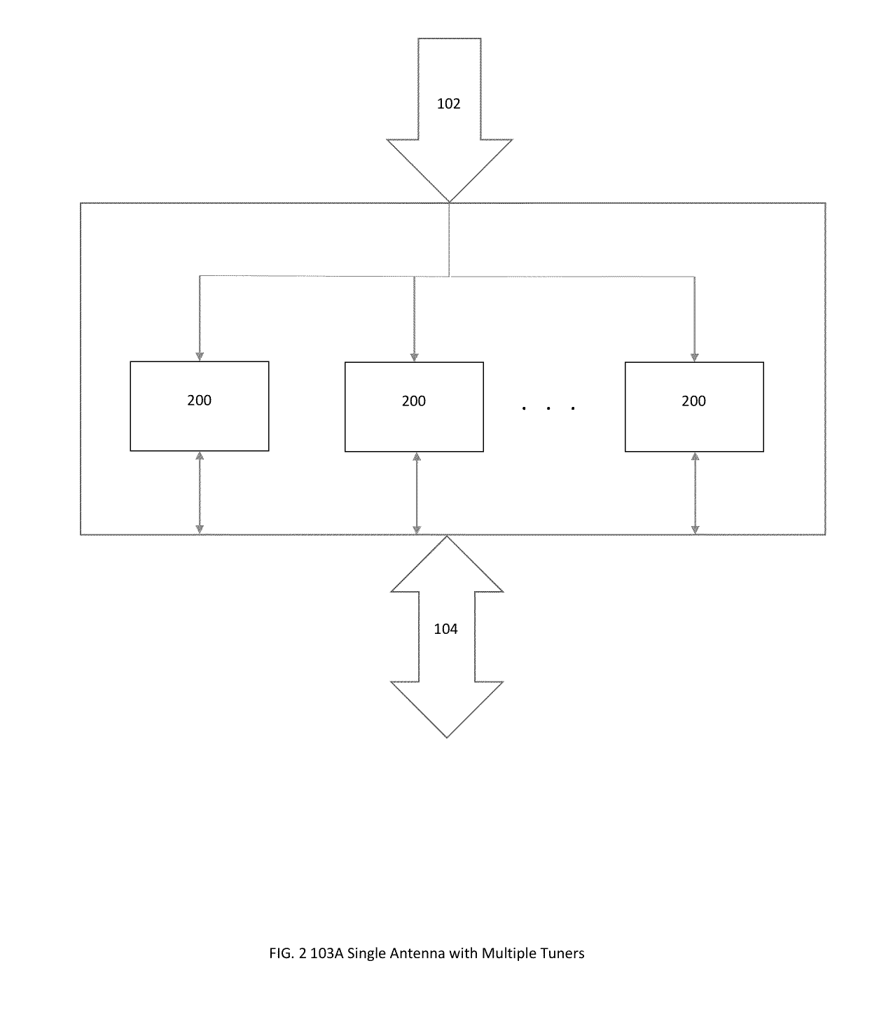

FIG. 2: 103A—Single Antenna with Multiple Tuners
200—Wi-Fi TV Antenna

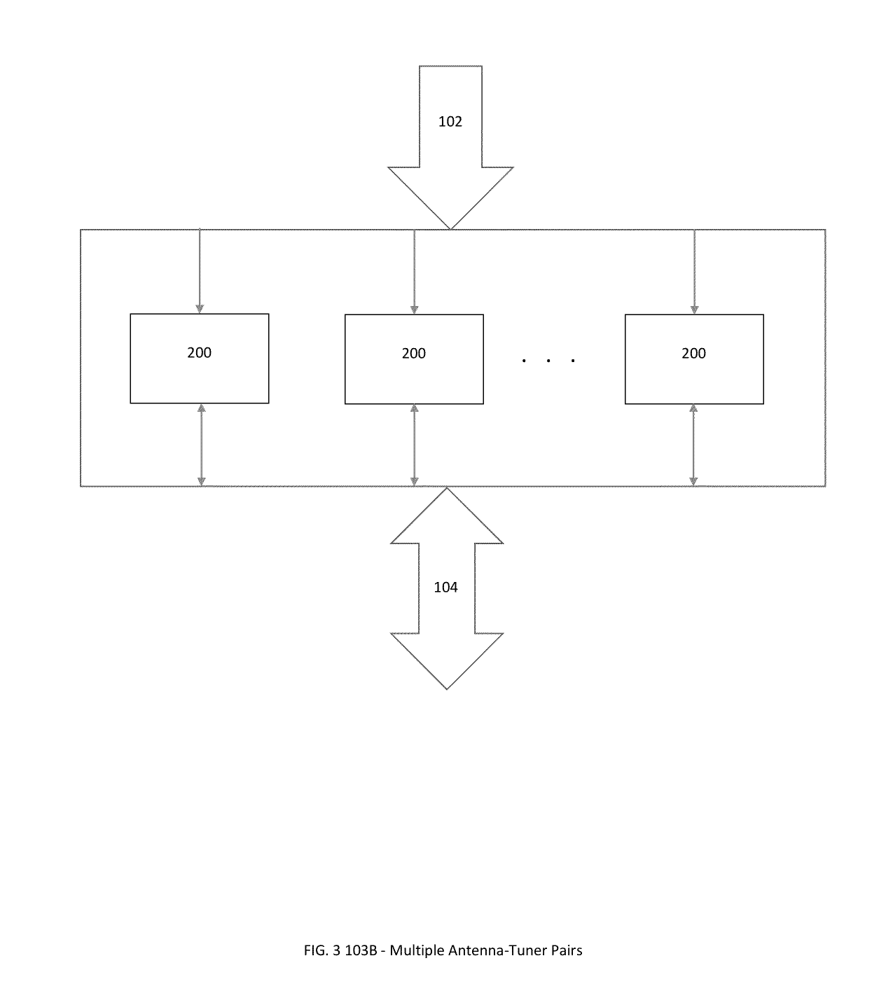

FIG. 3: 103B—Multiple Antenna-Tuner Pairs
200—Wi-Fi TV Antenna

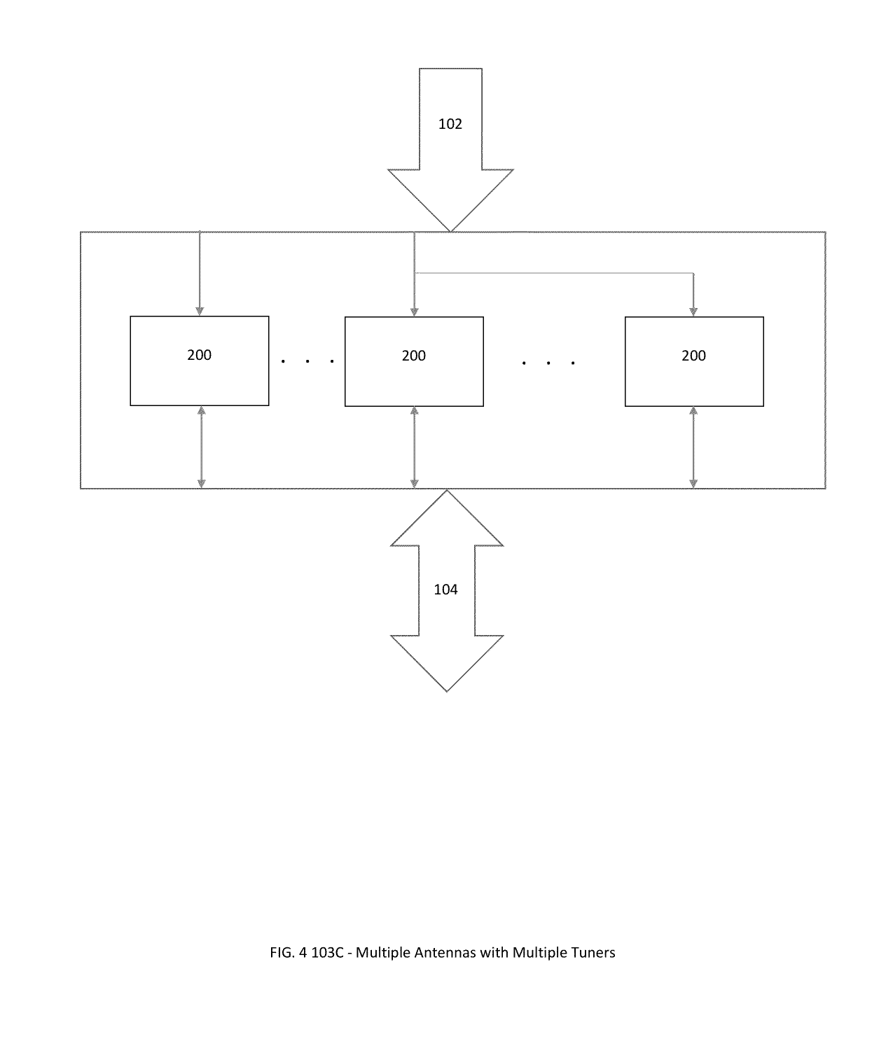

FIG. 4: 103C—Multiple Antennas with Multiple Tuners
200—Wi-Fi TV Antenna

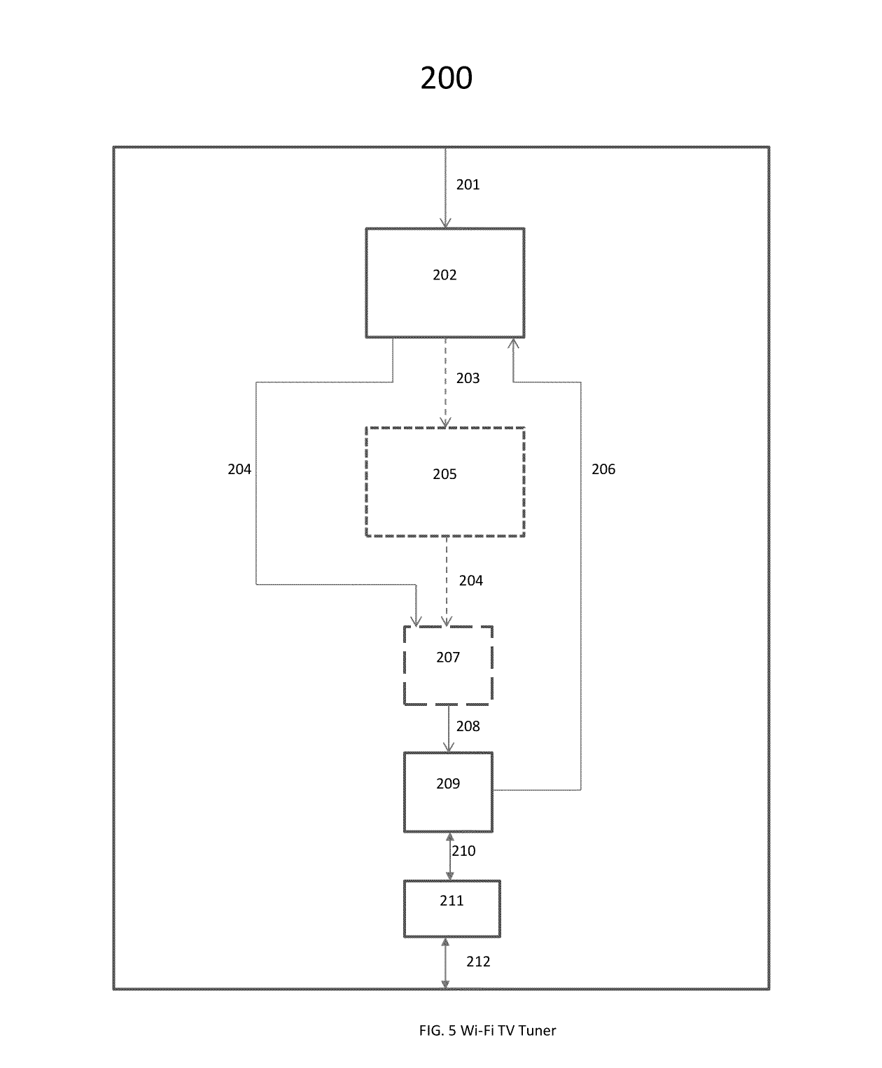

FIG. 5: 200—Wi-Fi TV Antenna
201—Antenna cable to tuner (same as 102 in FIG. 1)
202—TV Tuner (CAN, Silicon, etc.)
203—Analog IF TV Signal
204—Digital IF TV Signal
205—Analog to Digital Signal Converter (205 is optional if the ADC is built-in the Tuner)
206—Channel Tuning Signal and IF AGC (Automatic Gain Control) Signal
207—Waveform Data Compression Unit
208—Compressed Digital IF TV Signal
209—TV Signal to Wi-Fi Signal Adapter
210—Wi-Fi Interface Digital Signal
211—High Speed Wi-Fi Device
212—Wi-Fi RF Signal (wPCIe)

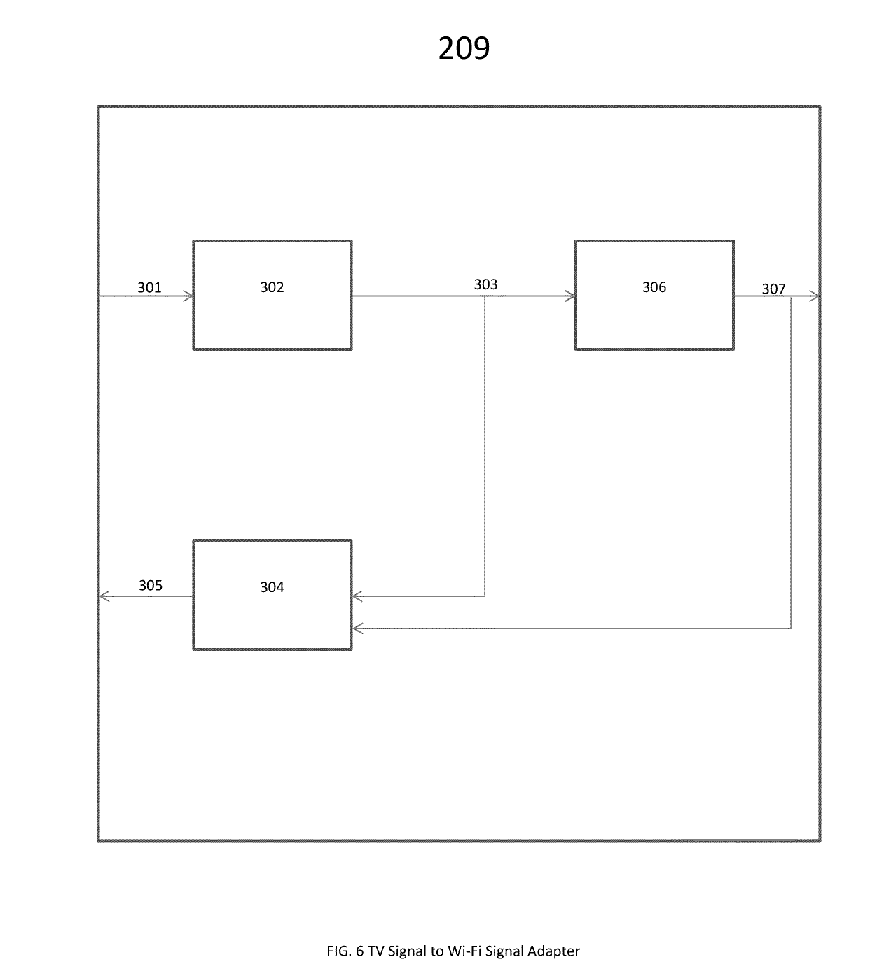

FIG. 6: TV Signal to Wi-Fi Signal Adapter
301—Digital IF TV Signal
302—Optional Low Pass Filter
303—Filtered Digital IF TV Signal
304—Channel Tuning Controller and Signal Strength Estimator
305—Channel Tuning Signal and IF AGC (Automatic Gain Control) Signal
306—TV Signal Adapter for High Speed Wi-Fi Device
307—Wi-Fi Interface Digital Signal

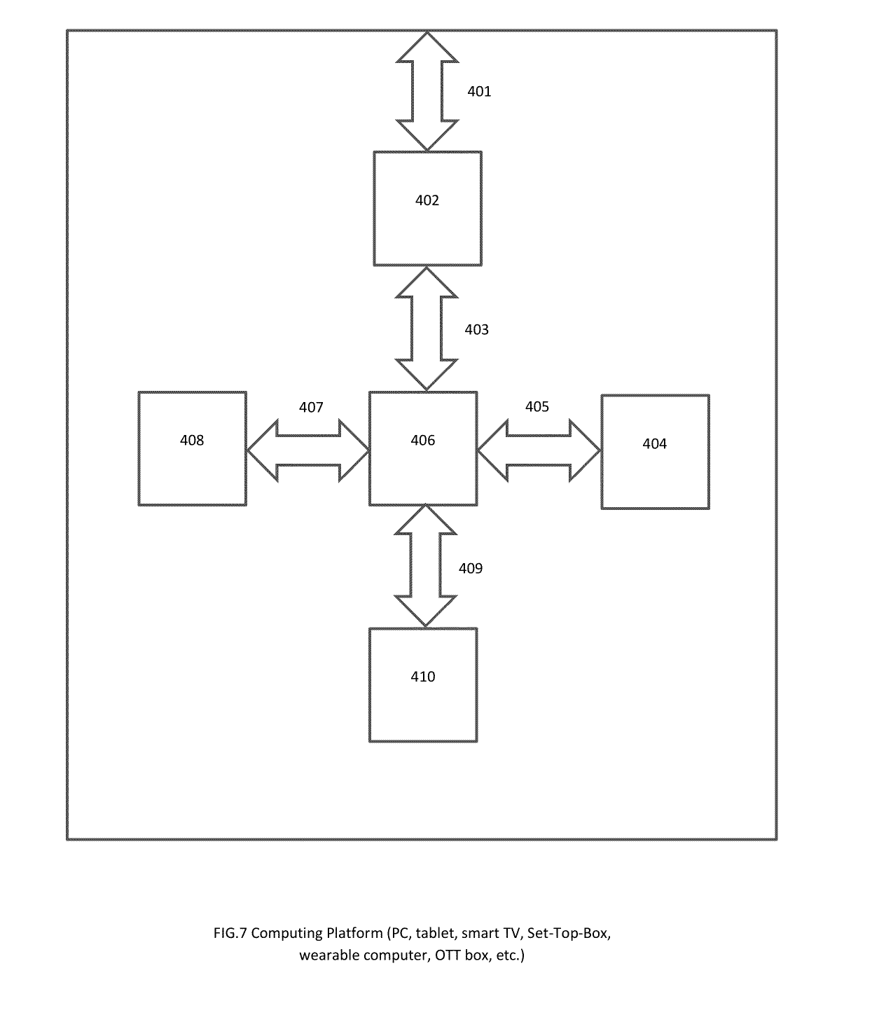

FIG. 7: 105—Computing platform (PC, tablet, smart TV, Set-Top-Box, OTT box, wearable computer, etc.)
401—Wi-Fi RF Signal (wPCIe)
402—I/O Controller Hub (ICH)
403—Direct Media Interface (DMI)
404—System Memory (DRAM)
405—Double Data Rate (DDR) Bus
406—Graphics and Memory Control Hub (GMCH)
407—PCIe Bus
408—Graphics Card
409—Front Side Bus (FSB)
410—Central Processing Unit (CPU)

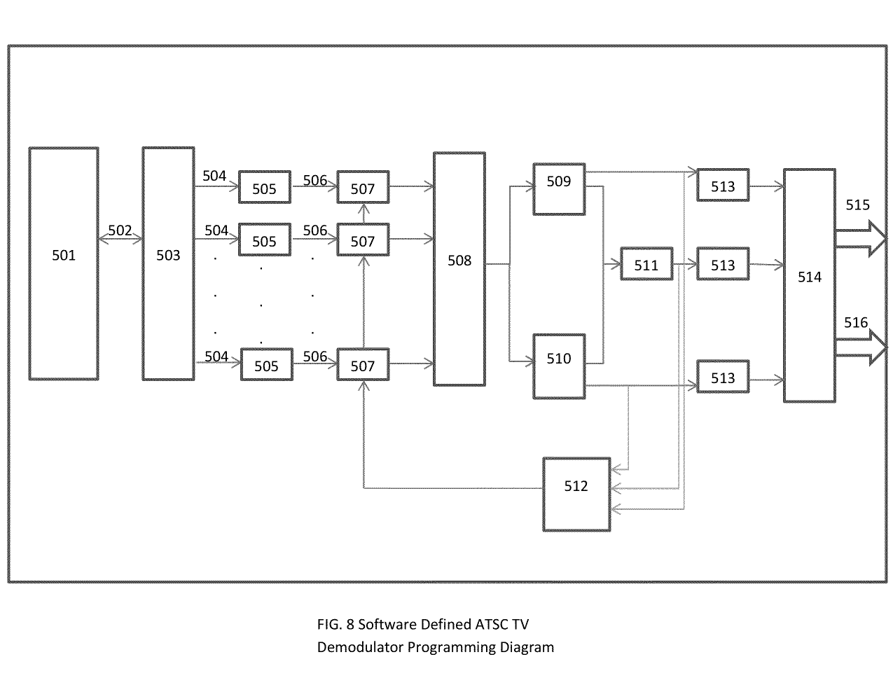

FIG. 8: Software Defined ATSC TV Demodulator Programming Diagram
501—System Memory (also 404 in FIG. 7)
502—Multiplexed Multiple Tuner Digital IF Signal Block
503—Multiple Tuner IF Signal De-multiplexing and Waveform Decompression Functional Block
504—Single Tuner Digital IF Signal Block
505—IF to Baseband down-conversion and signal synchronization Functional Block
506—Synchronized Baseband Signal Block for each Tuner
507—Channel State Estimation and Signal-To-Noise-Ratio (SNR) Estimation Functional Block for each Tuner
508—Signal-to-noise ratio (SNR) Weighted Combining Functional Block for multiple tuners
509—Frequency Domain Maximum Ratio Combining (MRC) Equalizer Functional Block
510—Time Domain Maximum Ratio Combining (MRC) Equalizer Functional Block
511—Equal Gain Combining Functional Block
512—Selective Combining Slicing Functional Block
513—Forward Error Correction (FEC) Functional Block: includes Viterbi Decoder, De-interleaver, R. S. Decoder, and De-randomizer
514—Selective Combining Functional Block
515—Output Signal as MPEG TS Signal Block for Display Processing
516—Output Signal as MPEG TS Signal Block to Hard Drive for Recording

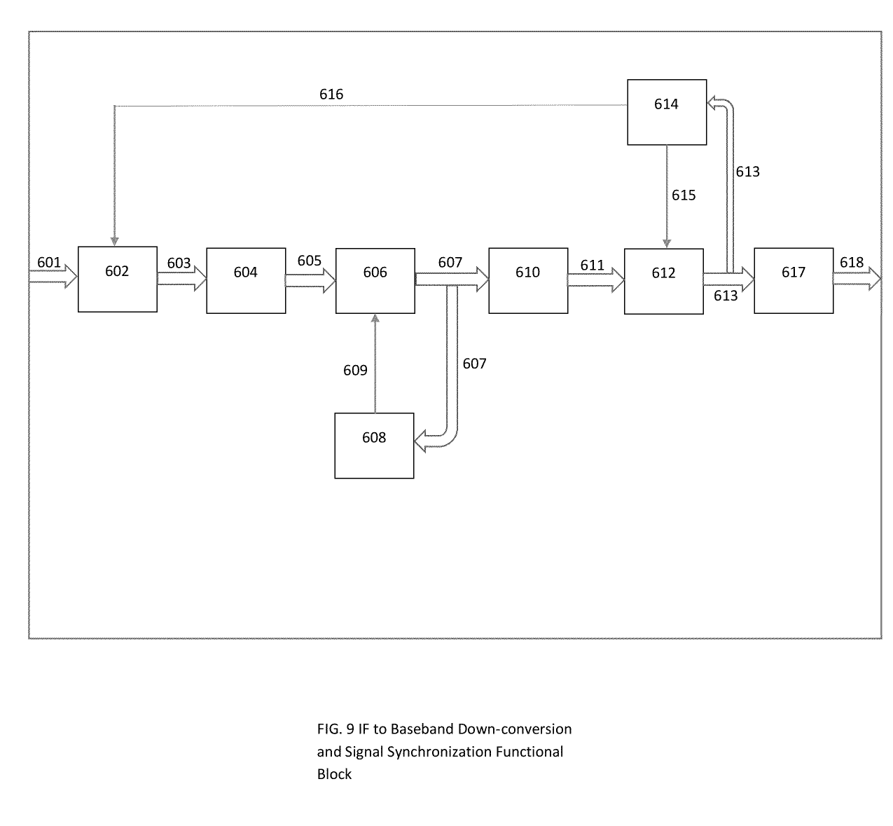

FIG. 9: 505—IF to Baseband Down-conversion and Signal Synchronization
601—Single Tuner Digital IF Signal Block (also 504 in FIG. 8)
602—IF to Baseband Down-conversion Functional Block
603—Baseband Signal (6 MHz bandwidth) Block
604—Adjacent Channel Filtering (ACF) Functional Block
605—ACF Output Signal Block
606—Symbol Timing Recovery Functional Block
607—2× Symbol Rate Baseband Signal Block
608—Timing Error Detection Functional Block
609—Timing Error Correction Parameters
610—SRRC Filtering and Frequency Shifter Functional Block
611—SRRC Output Signal Block
612—Phase Error Correction Functional Block
613—Synchronized Baseband Signal Block
614—Phase and Frequency Error Detection Functional Block
615—Phase Error Correction Parameters
616—Frequency Error Correction Parameters
617—Decimation and Field Synchronization Functional Block
618—Symbol Rate Synchronized Baseband Signal Block

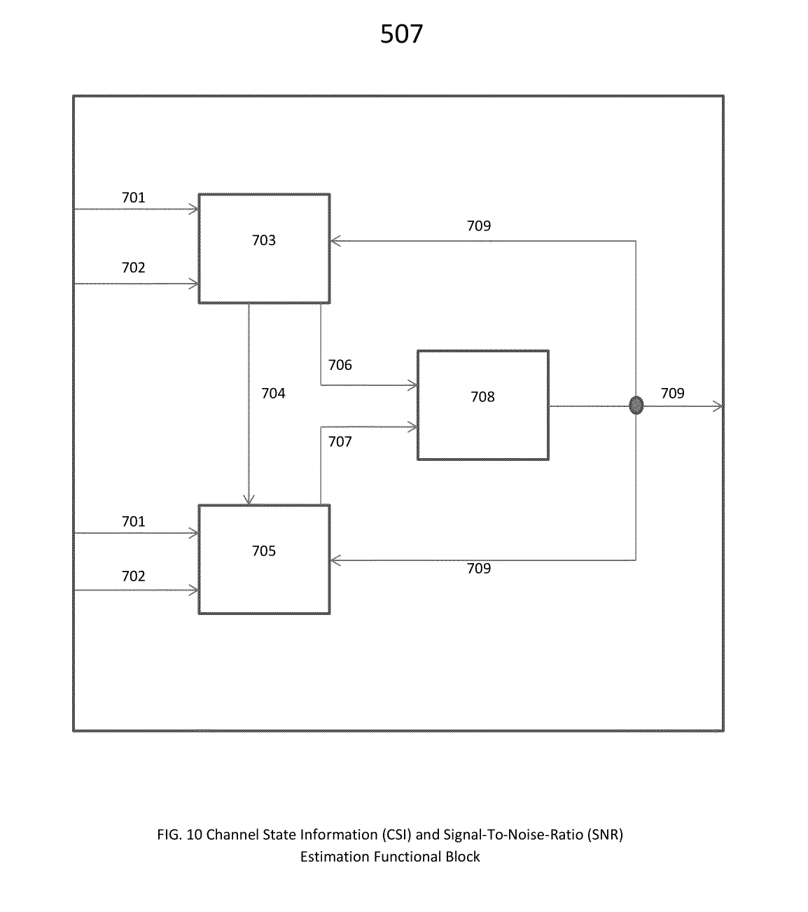

FIG. 10: 507—Channel State Information (CSI) and Signal-To-Noise-Ratio (SNR) Estimation Functional Block
701 (also 618 in FIG. 9)—Symbol Rate Synchronized Baseband Signal Block
702—Output Signal Block of the Selective Combining Slicing Functional Block (512 in FIG. 8)
703—Time Domain Iterative CSI & SNR Estimation Functional Block
704—Initial channel impulse response
705—Frequency Domain Iterative Channel Frequency Response Estimation Functional Block
706—CSI and SNR Parameters
707—Channel State Information Parameters
708—Weighted Combining Functional Block for channel impulse response
709—Channel State Information Parameters

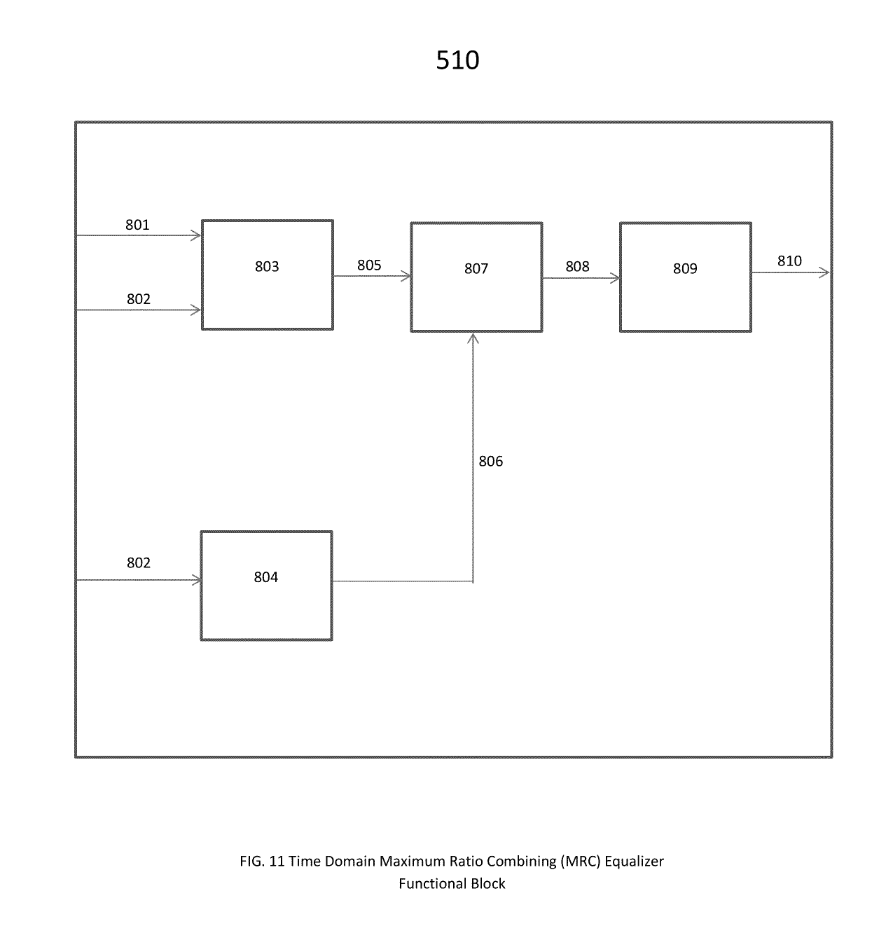

FIG. 11: 510—Time Domain Maximum Ratio Combining (MRC) Equalizer Functional Block
801—Symbol Rate Synchronized Baseband Signal Block
802—CSI and SNR Parameters
803—MRC (Maximum Ratio Combining) Frequency Domain Equalizer Functional Block
804—MMSE (Minimum Means Square Error) Optimized Noise Whitening Filter Coefficient Generator Functional Block
805—MRC Equalized Signal Block with Colored Noise
806—MMSE Optimized Noise Whitening Filter Coefficients
807—MMSE Optimized Noise Whitening Filter Functional Block
808—Filtered MRC Equalized Signal Block with White Noise
809—Decision Feedback Equalizer Functional Block
810—Demodulated ATSC TV Signal Block

FIG. 1 is an example of the Software Defined ATSC TV Demodulator with Wi-Fi Tuners (100). Any terrestrial TV will have a common TV Antenna (101) to receive the radio waveforms. Traditionally, the TV antenna is directly plugged in to the TV through an antenna cable (102). In this invention, the antenna cable is first connected to the Wi-Fi TV Antenna Module (103), which traditionally is inside the TV. This invention 1) has separated the tuners from the demodulator of the TV receiver, and put the tuners on the TV antenna side; 2) uses a Wi-Fi RF Signal (104) to connect the tuners to the demodulator of the TV receiver; and 3) uses Software Defined Radio (SDR) technology to implement the demodulator of the TV receiver on the computing platform (105).

FIG. 2 is an example of a Single Antenna with Multiple Tuners (103A). The single antenna cable (102) will connect to multiple Wi-Fi TV Antennas (200). Each tuner may tune to the same or different TV channels as the other tuners.

FIG. 3 is an example of Multiple Antenna-Tuner Pairs (103B). Each of the multiple antenna cables (102) will connect to each of the Multiple Wi-Fi TV Antennas (200) individually. Each tuner may tune to the same or different TV channels as the other tuners.

FIG. 4 is an example of Multiple Antennas with Multiple Tuners (103C). The multiple antenna cables (102) will connect to multiple Wi-Fi TV Antennas (200) as a combination case of 103A (see FIGS. 2) and 103B (see FIG. 3). Each tuner may tune to the same or different TV channels as the other tuners.

FIG. 5 is an example of a Wi-Fi TV Antenna (200). The antenna cable (201) is connected to a silicon or CAN TV tuner (202). If the tuner has an ADC (Analog to Digital Converter) built in, then the output IF ATSC TV signal of the tuner is in digital format (204). If the tuner does not have an ADC built in, then the output IF ATSC TV signal of the tuner is in analog format (203). So, the analog IF ATSC TV signal (203) will be transformed to digital format by the ADC (205).

The tuner needs a Channel Tuning Signal and an IF AGC (Automatic Gain Control) Signal (206) to control the tuner to the desired channel and control the tuner's signal dynamic range.

The Digital IF TV Signal (204) is a sampled waveform. The minimum sampling frequency (Nyquist Sampling Rate) is two times the ATSC TV signal baseband symbol rate which is 10.76 MSPS (Mega Symbols per Second). Any sampling frequency above the minimum sampling frequency can be used. In this example, the sampling frequency is 25 MHz and the ADC is 12-bit, therefore the Digital IF TV Signal (204) data rate is 300 Mbps (Mega Bits per Second). Since the bandwidth of the ATSC TV signal is 6 MHz, there is redundant information in the sampled digital IF TV signal (204). The waveform data compression unit (207) is applied to the sampled digital IF TV signal (204) in order to remove the redundancy and reduce the data rate of the signal.

The waveform data compression algorithm in 207 can be either the ADPCM (Adaptive Differential Pulse-Code Modulation) algorithm or the DPCM (Differential Pulse-Code Modulation) algorithm. For this example, the ADPCM algorithm is used. The output of the Waveform Data Compression Unit (207) is a Compressed Digital IF TV Signal (208) with the data rate of 100 Mbps. The Compressed Digital IF TV Signal (208) is fed in to the TV to Wi-Fi Adapter (209).

The waveform data compression unit (207) will not be needed if the Wi-Fi bandwidth is large enough to support the uncompressed data rate.

The TV to Wi-Fi Adapter (209) generates a Wi-Fi interface digital signal (210). This signal directly feeds in to the High Speed Wi-Fi Device (211). The High Speed Wi-Fi Device (211) can be based on the Wi-Fi Standard 802.11n, 802.11ac, 802.11ad, 802.11af, etc. The output of 211 is the Wi-Fi RF Signal (212), which can be a wireless Peripheral Component Interconnect express (wPCIe). The TV to Wi-Fi Adapter (209) also generates a Channel Tuning Signal and an AGC signal (206) for the tuner (202).

FIG. 6 is an example of a TV Signal to Wi-Fi Signal Adapter (209). The digital IF ATSC TV signal (301, also 208 FIG. 5) goes in to the optional low pass filter (302) to remove the adjacent channel interference. This filtered digital IF TV signal (303) and the Channel Tuning Signal from 307 go to the Channel Tuning

Controller and Signal Strength Estimator (304) which generates a Channel Tuning Signal and an IF AGC signal (305, also 206 FIG. 5). The filtered signal (303) also goes in to a high speed Wi-Fi interface signal adapter, which is the TV Signal Adapter for High Speed Wi-Fi Device (306), to generate a Wi-Fi Interface Digital Signal (307, also 210 FIG. 5) to the High Speed Wi-Fi Device (211).

The ATSC signal consists of continuous fields. Each field has a duration of 24 milliseconds. A field consists of 313 segments—the first is the Field Synchronization segment, followed by 312 data segments. For every Wi-Fi transceiver signal burst, the High Speed Wi-Fi Device (211) will transfer one ATSC signal field. Since the ATSC signal is continuous and the Wi-Fi transceiver signal is a burst, the TV Signal Adapter for High Speed Wi-Fi Device (306) needs a memory unit as a data buffer for Wi-Fi transceiver data transfer. Assuming the sampling rate is 25 MHz and the ADC is 12-bit, the uncompressed Digital IF TV Signal (204) data rate is 300 Mbps (Megabits per second). Each uncompressed 24 millisecond ATSC signal field is 900 kilobytes. For a compressed Digital IF TV signal, each 24 millisecond ATSC signal field is 300 kilobytes. The memory unit size for the data buffer needs to be large enough to hold one ATSC signal field (i.e. between 100 kilobytes and 1 megabyte).

FIG. 7 is an example of a computing platform, which can be a PC, tablet, smart TV, Set-Top-Box, wearable computer, Over-The-Top box, etc. A computing platform consists of a single core, multi-core, or many-core CPU (410), a front side bus (409), a graphics card (408), a PCIe bus (407), a Graphics and Memory Control Hub (GMCH) (406), a Double Data Rate (DDR) Bus (405), System Memory (DRAM) (404), a Direct Media Interface (DMI) (403), and an I/O Controller Hub (ICH) (402).

A Wi-Fi RF Signal (wPCIe) (401 in FIG. 7, 307 in FIGS. 6, and 210 in FIG. 5) is the wireless interface between the computing platform and its peripheral Wi-Fi TV Antennas. The computer platform will tune the Wi-Fi TV antenna to different channels through the Wi-Fi RF Signal (401). During the TV reception process, for each Wi-Fi transceiver signal burst, a Wi-Fi RF Signal (401) will transfer one 24 millisecond ATSC TV signal field from each Wi-Fi TV antenna to the system memory (404) in real time.

Once the data is in the system memory, the Software-Defined ATSC TV Demodulator will start processing.

FIG. 8 is an example of the Software Defined ATSC TV Demodulator Programming Diagram.

The System Memory (501) provides the input signal data to the ATSC TV demodulator program. The Multiplexed Multiple Tuner Digital IF Signal (502) from the system memory (501) feeds in to the Multiple Tuner IF Signal De-multiplexer and Waveform De-compressor (503). The de-multiplexed single tuner digital IF signal was compressed using ADPCM encoder algorithm as described above in FIG. 5. The de-compressor is composed of ADPCM decoder algorithm to restore the original ATSC digital IF signal for each tuner.

The ATSC TV demodulator signal processing program is based on data blocks. The data blocks must be processed in real time. In this example, the data block is defined as two segments of ATSC TV signal. Each segment of ATSC TV signal has a duration of 77.266 microseconds and consists of 832 symbols with a sampling rate of 10.76 MHz. Each Single Tuner Digital IF Signal Block (504) consists of 3865 or 3866 12-bit data samples with a sampling rate at 25 MHz, which corresponds to two segments of ATSC TV signal. The signal block of 504 will feed in to the IF to Baseband Down-conversion and Signal Synchronization Functional Block (505), which will be detailed in the FIG. 9 description below. The functional block 505 generates a Synchronized Baseband Signal Block for each Tuner (506).

Given a baseband signal block from each tuner of 506, and the feedback signal from the functional block 512, the functional block 507 (detailed in FIG. 10 description) will estimate the multipath channel profile and analyze the multipath channel impulse response and signal-to-noise ratio for each tuner.

Based on the results from each functional block 507, the functional block 508 performs weighted combining for normalization of signal-to-noise ratio from multiple tuners.

The weighted combined signal block output from the functional block 508 will feed in to both the Frequency Domain Maximum Ratio Combining Equalizer Functional Block (509) and the Time Domain Maximum Ratio Combining Equalizer Functional Block (510, detailed in FIG. 11 description). The results from the two equalizer functional blocks (509 and 510) will be further combined using an Equal Gain Combining Functional Block (511) to generate an optimal time and frequency domain combined signal block.

Now there are three signal blocks from 509, 510 and 511—these three signal blocks will pass through the Selective Combining Slicing Functional Block (512) to generate optimal feedback to the functional block 507. These three signal blocks will also simultaneously pass thru the functional block 513 (feed forward path).

Now use the Selective Combining Functional Block (514) to pick the best one output of the three (frequency, time, equal gain). The output will be either the Output Signal as MPEG TS Signal Block for Display Processing (515) or the Output Signal as MPEG TS Signal Block to Hard Drive for Recording (516).

FIG. 9 is an example of IF to Baseband Down-conversion and Signal Synchronization. The signal block size of 601 ranges between 3865-3866 data samples. The functional block 602 can process the signal block 601 using either a sample-based (sequentially) or vector-based (in parallel) algorithm. The functional block 602 down-converts the digital IF signal into a baseband signal based on Frequency Error Correction Parameters (616). The output of the IF to Baseband Down-conversion Functional Block (602) is the Baseband Signal (6 MHz bandwidth) Block (603). The signal block size of 603 ranges between 3865-3866 data samples. The functional block 604 filters out the adjacent channel noise using a Finite Impulse Response (FIR) filter. The ACF FIR filter has 156 taps (complex values). In this example, the vector-based algorithm for the ACF FIR filter is implemented.

The functional block 604 performs the following steps: 1) extend the size of signal block 603 to 4096 data samples by appending zero-value samples to the end of the signal block; 2) transfer the new 4096-sample data block into frequency domain by using Fast Fourier Transform (FFT); 3) load the pre-calculated frequency response of the ACF filter from the system memory; 4) multiply the frequency response of the baseband signal from step 2 with the frequency response of the ACF filter from step 3;5) transfer the results of step 4 back to time domain using Inverse Fast Fourier Transform (IFFT); and 6) recover the time domain baseband signal by using the Overlap-Add algorithm.

The output of functional block 604 is the ACF Output Signal Block (605). The signal block size of 605 ranges between 3865-3866 data samples.

The functional block 606 can process the signal block 605 using either a sample-based (sequentially) or vector-based (in parallel) algorithm. The functional block 606 recovers the symbol timing of the baseband signal of 605, based on Timing Error Correction Parameters (609). The functional block 606 is implemented using an interpolation filter (3 or 4 taps). The output of the Symbol Timing Recovery Functional Block (606) is the 2× Symbol Rate Baseband Signal Block (607). The block size of 607 is 3328 (2×2×832) data samples, which is two segments of ATSC signal. The Timing Error Detection Functional Block (608) takes the signal block 607 as input and calculates the symbol timing error between the receiver signal sampling clock and the ATSC TV transmitter signal symbol clock. This calculated error is the Timing Error Correction Parameters (609), which feeds back in to functional block 606.

The SRRC Filtering and Frequency Shifter Functional Block (610) is the low-pass FIR filter. The SRRC FIR filter has 128 taps (complex values). In this example, the vector-based algorithm for the SRRC FIR filter is implemented. The functional block 610 performs the following steps: 1) extend the size of signal block 607 to 4096 data samples by appending zero-value samples to the end of the signal block; 2) transfer the new 4096-sample data block into frequency domain by using Fast Fourier Transform (FFT); 3) load the pre-calculated frequency response of the SRRC filter from the system memory; 4) multiply the frequency response of the baseband signal from step 2 with the frequency response of the SRRC filter from step 3; 5) shift the baseband central frequency in frequency domain by 2.689 MHz; 6) transfer the results of step 5 back to time domain using IFFT; and 7) recover the time domain baseband signal by using the Overlap-Add algorithm.

The output of functional block 610 is the SRRC Output Signal Block (611). The signal block size of 611 is 3328 data samples.

The Phase Error Correction Functional Block (612) recovers the phase of the sampled data, the SRRC Output Signal, based on Phase Error Correction Parameters (615). The output of the Phase Error Correction Functional Block (612) is the Synchronized Baseband Signal Block (613). The block size of 613 is 3328 (2×2×832) data samples, which is two segments of ATSC signal.

The Phase and Frequency Error Detection Functional Block (614) takes the signal block 613 as input and calculates both the frequency and phase error between the receiver RF signal and the ATSC TV transmitter RF signal. The calculated Phase Error is Phase Error Correction Parameters (615), which feeds back to functional block 612. The calculated frequency error is the Frequency Error Correction Parameters (616), which feeds back in to functional block 602.

The functional block 617 first decimates the 3328 data blocks into 1664 data blocks, then synchronizes the two segments of symbol rate data based on the field synchronization sequence. The purpose of the field synchronization sequence is to find where each data segment of the ATSC signal starts in each field of ATSC TV signal.

The output of functional block 617 is the Symbol Rate Synchronized Baseband Signal Block (618). The signal block size of 618 is 1664 data symbols.

FIG. 10 is an example of the Channel State Information (CSI) and Signal-To-Noise-Ratio (SNR) Estimation Functional Block.

The ATSC field-sync sequence in the Symbol Rate Synchronized Baseband Signal Block (701) and the Output Signal Block of the Selective Combining Slicing Functional Block (702) goes in to the Time Domain Iterative CSI & SNR Estimation Functional Block (703) to initialize and update the Channel Impulse Response (704). The Time Domain Iterative CSI & SNR Estimation Functional Block (703) is using either the Least Means Square (LMS) or the Recursive Least Square (RLS) algorithm. In general, the channel impulse response, also called Channel State Information Parameters (709), is time variant. Therefore, 703 is using previously estimated Channel State Information Parameters (709) as a reference to iteratively update the time variant channel impulse response. Because of the time variant nature of the channel impulse response in the ATSC TV reception environment, an Output Signal Block of the Selective Combining Slicing Functional Block (702) must be used in-between the field sync signals in 701. The output of the Time Domain Iterative CSI & SNR Estimation Functional Block (703) is CSI and SNR Parameters (706), which goes to the Weighted Combining Functional Block for channel impulse response (708).

Optionally, in addition to using a Time Domain Iterative CSI & SNR Estimation Functional Block (703), a Frequency Domain Iterative Channel Frequency Response Estimation Functional Block (705) can be used, given the initial channel impulse response (704).

In the Frequency Domain Iterative Channel Frequency Response Estimation Functional Block (705), the following algorithm is used:
1. Zero padding guard interval data segment reference signal generation.
2. Pre-segment and post-segment data removal of the Symbol Rate Synchronized Baseband Signal Block (701) for each segment.
3. Fast Fourier Transform (FFT) and Inverse Fast Fourier Transform (IFFT) are used to do the transformation between channel impulse response and frequency response.

The output Channel State Information Parameters (707) are generated from the Frequency Domain Iterative Channel Frequency Response Estimation Functional Block (705).

The Weighted Combining Functional Block for channel impulse response (708) combines the Channel State Information Parameters of 706 from the Time Domain Iterative CSI & SNR Estimation Functional Block (703) with the Channel State Information Parameters (707) from the Frequency Domain Iterative Channel Frequency Response Estimation Functional Block (705) to generate Channel State Information Parameters (709) for each ATSC TV signal segment.

FIG. 11 is an example of the Time Domain Maximum Ratio Combining (MRC) Equalizer Functional Block (also 510 in FIG. 8).

801 is the Symbol Rate Synchronized Baseband Signal Block. 802 is the CSI and SNR Parameters, which includes channel impulse response and Signal-To-Noise Ratio (SNR). Both 801 and 802 go to the MRC (Maximum Ratio Combining) Frequency Domain Equalizer Functional Block (803) for combining and equalization. The equalized results (805) have colored noise because of the noise enhancement effects during the equalization process. In order to remove the colored noise from the equalized signal, a noise whitening filter is needed. The Minimum Means Square Error (MMSE) Optimized Noise Whitening Filter Coefficient Generator Functional Block (804) generates the MMSE Optimized Noise Whitening Filter Coefficient based on 802. The algorithm of functional block 804 is based on MMSE-DFE theory (J. M. Cioffi and G. Dudevoir and M. V. Eyuboglu and G. D. Forney, Jr. “Minimum Means-Square-Error Decision Feedback Equalization and Coding—Parts I and II”. IEEE Transactions on Communications, October 1995). Either the Givens rotations or Householder reflections for QR factorization can be used in 804. The MMSE Optimized Noise Whitening Filter Functional Block (807) uses the MMSE Optimized Noise Whitening Filter Coefficients (806) to remove the colored noise of the MRC Equalized Signal Block with Colored Noise (805) and outputs the Filtered MRC Equalized Signal Block with White Noise (808). The Decision Feedback Equalizer Functional Block (809) uses the MMSE Optimized Noise Whitening Filter Coefficients (806) as its filter coefficient to generate a Demodulated ATSC TV Signal Block (810) from the Filtered MRC Equalized Signal Block with White Noise (808).

What is claimed is:

1. A software defined ATSC TV Demodulator with Wi-Fi Tuners comprising of:
a. One or more ATSC TV Tuners,
b. A computing platform (PC, laptop, tablet, smart phone, wearable computing device, Over-The-Top box, etc.),
c. The wireless interface (Wi-Fi) device,
d. The wireless interface (Wi-Fi) transport stream protocol between the ATSC TV tuner(s) and the computing platform through the wireless interface (Wi-Fi) device, which performs the following functions:
i. Compress/Decompress or Un-compress the ATSC TV Digital IF Signal
ii. Segment the continuous ATSC TV signal into blocks (i.e. one field of ATSC TV signal per block)
iii. Pass channel tuning and IF AGC (Automatic Gain Control) information
iv. Transform the TV Signal to a Wi-Fi Signal and Wi-Fi signal to a TV signal
e. The vector-based digital signal processing algorithm for each individual functional block, which performs the following functions:
i. IF to Baseband down-conversion and signal synchronization Functional Block
ii. Channel State Estimation and Signal-To-Noise-Ratio (SNR) Estimation Functional Block for each Tuner
iii. Signal-to-noise ratio (SNR) Weighted Combining Functional Block for multiple tuners
iv. Frequency Domain Maximum Ratio Combining (MRC) Equalizer Functional Block
v. Time Domain Maximum Ratio Combining (MRC) Equalizer Functional Block
vi. Equal Gain Combining Functional Block
vii. Selective Combining Slicing Functional Block
viii. Forward Error Correction (FEC) Functional Block: includes Viterbi Decoder, De-interleaver, R. S. Decoder, and De-randomizer
ix. Selective Combining Functional Block

2. A device of claim 1a with:
a. one or more non-ATSC tuners
b. Silicon tuner or CAN tuner
c. Single channel tuner or multiple channel tuner
d. Broadband digital channel filter

3. A device of claim 1b with:
a. A conventional computing platform (e.g. PC, laptop, tablet, smart TV, Set-Top Box, Over-The-Top Box, etc.)
b. Cloud-based computing platforms
c. Wearable computing platforms
d. A computing platform which consists of a single core, multi-core, or many-core CPU
e. A computing platform with basic functional units, which includes but is not limited to: a front side bus, a graphics card, a PCIe bus, a Graphics and Memory Control Hub (GMCH), a Double Data Rate (DDR) Bus, System Memory (DRAM), a Direct Media Interface (DMI), and an I/O Controller Hub (ICH)
f. A computing platform with an operating system, which can be but is not limited to: Windows, UNIX, Linux, Android, iOS, etc.

4. A device of claim 1c with:
a. 802.11ac device
b. 802.11ad device
c. Any other wireless PCIe device
d. Any other high speed wireless communication device

5. A program of claim 1d(i) with:
a. ADPCM waveform compression algorithm
b. Any other digital compression algorithms

6. A program of claim 1d(ii) with:
a. One field (313 segments) of ATSC TV signal per block
b. Any other number of segments of ATSC TV signal per block

7. A program of claim 1d(iii) with:
a. Channel tuning and IF AGC (Automatic Gain Control) information
b. Any other information (i.e. network control) to enhance the TV reception functionality and performance

8. A program of claim 1d(iv) with:
a. TV Signal to intermediate Wi-Fi Signal and intermediate Wi-Fi signal to TV signal transformation
b. Any other intermediate Wi-Fi signal format, wired or wireless (e.g. power line communication)

9. A program of claim le implemented in:
a. C/C++, Python, Java, OpenCL, OpenGL, MatLab, etc.
b. Cuda and any other proprietary computer languages
c. Sequential programming methodology (i.e. single CPU)
d. Parallel programming methodology (i.e. multi-core, many core CPU)

10. A program of claim le(i) with:
a. Vector-based IF to Baseband down-conversion and signal synchronization functional Block
b. Sample-based IF to Baseband down-conversion and signal synchronization functional Block
c. A sampling frequency of the data samples that is, but not limited to, 25 Mhz per second
d. A vector (data block) size that is, but not limited to, two segments of ATSC signal samples
e. IF to Baseband down-conversion functional block
f. Adjacent Channel Filtering (ACF) functional block
g. Symbol Timing Recovery functional block
h. Timing Error Detection functional block
i. SRRC Filtering and Frequency Shifter functional block
j. Phase Error Correction functional block
k. Phase and Frequency Error Detection functional block
l. Decimation and Field Synchronization functional block

11. A program of claim 1e(ii) with:
a. Vector-based Channel State Estimation and Signal-To-Noise-Ratio (SNR) Estimation functional block for each tuner
b. Symbol-based Channel State Estimation and Signal-To-Noise-Ratio (SNR) Estimation functional block for each tuner
c. A symbol rate of 10.76 Mega Symbols per Second as per ATSC specification
d. A vector (data block) size that is, but not limited to, two segments of ATSC signal symbols
e. Time Domain Iterative CSI & SNR Estimation functional block
f. Frequency Domain Iterative Channel Frequency Response Estimation functional block
g. Weighted Combining functional block for channel impulse response

12. A program of claim 1e(iii) with:
a. Vector-based Signal-to-noise ratio (SNR) Weighted Combining functional block for multiple tuners
b. Symbol-based Signal-to-noise ratio (SNR) Weighted Combining functional block for multiple tuners

13. A program of claim 1e(iv) with:
a. Vector-based Frequency Domain Maximum Ratio Combining (MRC) Equalizer functional block based on Fast Fourier Transform (FFT) and Inverse Fast Fourier Transform (IFFT)
b. The size of the FFT and IFFT is, but not limited to, 4096

14. A program of claim 1e(v) with:
a. Vector-based Time Domain Maximum Ratio Combining (MRC) Equalizer functional block
b. Vector-based MRC (Maximum Ratio Combining) Frequency Domain Equalizer functional block based on Fast Fourier Transform (FFT) and Inverse Fast Fourier Transform (IFFT)
c. The size of the FFT and IFFT is, but not limited to, 4096
d. Vector-based MMSE (Minimum Means Square Error) Optimized Noise Whitening Filter Coefficient Generator functional block
e. Symbol-based MMSE (Minimum Means Square Error) Optimized Noise Whitening Filter Coefficient Generator functional block
f. Vector-based MMSE Optimized Noise Whitening Filter functional block based on Fast Fourier Transform (FFT)
g. Vector-based Decision Feedback Equalizer functional block
h. Symbol-based Decision Feedback Equalizer functional block

15. A program of claim 1e(vi) with:
a. Vector-based Equal Gain Combining functional block
b. Symbol-based Equal Gain Combining functional block

16. A program of claim 1e(vii) with:
a. Vector-based Selective Combining Slicing functional block
b. Symbol-based Selective Combining Slicing functional block

17. A program of claim 1e(viii) with:
a. Vector-based Forward Error Correction (FEC) functional block: includes Viterbi Decoder, De-interleaver, R. S. Decoder, and De-randomizer
b. Symbol-based Forward Error Correction (FEC) functional block: includes Viterbi Decoder, De-interleaver, R. S. Decoder, and De-randomizer

18. A program of claim 1e(ix) with:
a. Vector-based Selective Combining functional block
b. Symbol-based Selective Combining functional block
